(19) United States
(12) Patent Application Publication
(10) Pub. No.: US 2013/0272184 A1
(43) Pub. Date: Oct. 17, 2013

(54) SERVICE-PROVIDING SERVER, SERVICE-PROVIDING NODE, AND SERVICE-PROVIDING METHOD IN COMMUNICATION SYSTEM

(71) Applicants: Sung-Hee Kim, Daejeon (KR); Cheol-Hye Cho, Daejeon (KR); Won Ryu, Daejeon (KR)

(72) Inventors: Sung-Hee Kim, Daejeon (KR); Cheol-Hye Cho, Daejeon (KR); Won Ryu, Daejeon (KR)

(73) Assignee: Electronics and Telecommunications Research Institute, Daejeon (KR)

(21) Appl. No.: 13/880,559

(22) PCT Filed: Oct. 19, 2011
(86) PCT No.: PCT/KR2011/007779

§ 371 Date: Apr. 19, 2013

(30) Foreign Application Priority Data
Oct. 19, 2010 (KR) 10-2010-0101809

(51) Int. Cl. H04W 72/00

(52) U.S. Cl. CPC H04W 72/005
USPC 370/312

(57) ABSTRACT

A micro blog service providing method of a service providing server includes receiving a channel open request for a service from a user equipment (UE), registering a user service and a bearer service corresponding to the user service in a service providing node, for establishment of a multicast channel according to the channel open request, and transmitting a micro blog to the eMB-SC upon receiving the micro blog message from the UE.

### TECHNICAL FIELD

Exemplary embodiments of the present invention relate to communication systems; and, more particularly, to a service providing server, a broadcast/multicast service providing node, and a method for providing a micro blog service thereof, which can improve resource use efficiency.

### BACKGROUND ART

Current communication systems provide a micro blog service. The micro blog service is a kind of social network service (SNS) that enables users to create a human network on the Web.

A micro blog service is a kind of blog that enables users to communicate short messages of one or two sentences, which is also called a mini blog. Examples of the micro blog service include Twitter, MeToday, Daum Yozm, and KakaoSuda.

A Twitter service communicates users' opinions on various subjects through messages of 140 words or less. Twitter service users create a community through a follow relationship therebetween. The Twitter service enables the user to share and disseminate information.

The Twitter service transmits messages over numerous IP channels in wired Internet environments. Therefore, the Twitter service can transmit messages of 140 words or less to all followers in a unicast mode. However, when messages are unicast-transmitted to all followers in wireless Internet environments with limited network resources (e.g., mobile communication networks, WiBro Network, and wireless LAN), the Twitter service must allocate a wireless channel to each of the followers, thus degrading resource use efficiency.

### DISCLOSURE

### Technical Problem

An embodiment of the present invention is directed to a service providing server, a broadcast/multicast service providing node, and a method for providing a micro blog service thereof, which can improve resource use efficiency.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an exemplary embodiment of the present invention, a service providing server includes: a user service managing unit configured to register a user service in a multimedia broadcast/multicast service node (eMB-SC) according to a channel open request for a micro blog service of a user equipment (UE); a service channel managing unit configured to establish a bearer service corresponding to the user service upon registration of the user service; an application driving unit configured to drive a micro blog application to be used in the UE; and a micro blog interface unit configured to output and transmit a micro blog message, received from the UE, to UEs to receive the micro blog message, by the driving of the micro blog application.

In an exemplary embodiment, the service channel managing unit requests deregistration of the bearer service to the eMB-SC upon completion of the use of the user service by the UE.

In another exemplary embodiment, the user service managing unit requests deletion of the user service upon completion of the bearer service deregistration request.

In another exemplary embodiment, the service providing server further includes a micro blog message transmitting unit configured to converts the micro blog message into a micro blog packet supported by the eMB-SC, and transmits the micro blog packet to the eMB-SC.

In accordance with another exemplary embodiment of the present invention, a multimedia broadcast/multicast service node includes: a user service subscription/unsubscription processing unit configured to register a user service upon receiving a user service registration request from a service providing server; a service channel managing unit configured to receive a bearer service registration request according to the registration of the user service; a resource managing unit configured to allocate a resource for registration of a bearer service according to the bearer service registration request; a bearer setup managing unit configured to create a multicast channel through establishment of a bearer service according to the resource allocation; and a contents processing unit configured to receive a multicast message of a user equipment (UE) corresponding to the user service from the service providing server, and transmit the same over the multicast channel.

In an exemplary embodiment, upon receiving a bearer service deregistration request, the service channel managing unit recovers an allocated resource for the bearer service deregistration.

In another exemplary embodiment, upon receiving a user service deregistration request from the service providing server, the user service subscription/unsubscription processing unit deregisters the registered user service.

In another exemplary embodiment, for registration of a bearer service, the resource managing unit collects location information of UEs to receive a micro blog message.

In another exemplary embodiment, the bearer setup managing unit registers the bearer service on the basis of the location information of the UEs.

In another exemplary embodiment, the contents processing unit transmits the multicast message to UEs simultaneously over the multicast channel.

In accordance with another exemplary embodiment of the present invention, a micro blog service providing method of a service providing server includes: receiving a channel open request for a service from a user equipment (UE); registering a user service and a bearer service corresponding to the user service in a multimedia broadcast/multicast service node (eMB-SC), for establishment of a multicast channel according to the channel open request; and transmitting a micro blog to the eMB-SC upon receiving the micro blog message from the UE.

In an exemplary embodiment, the micro blog service providing method further includes: deregistering a bearer service from the eMB-SC upon detecting the need to disestablish the multicast channel; and deregistering a user service corresponding the bearer service upon completion of the deregistration of the bearer service.

In another exemplary embodiment, said transmitting a micro blog to the eMB-SC upon receiving the micro blog message from the UE includes: converting the micro blog message into a micro blog packet supported by the eMB-SS; and transmitting the micro blog packet to the eMB-SC.

In accordance with another exemplary embodiment of the present invention, a micro blog service providing method of a broadcast/multicast service node (eMB-SC) includes: receiving a user service registration request and a bearer service registration request from a service providing server; creating a multicast channel according to the user service registration and the bearer service registration; and receiving a micro blog message from the service providing server and transmitting the micro blog message over the multicast channel.

In an exemplary embodiment, the micro blog service providing method further includes: deregistering the bearer service according to the bearer service deregistration request; and deregistering a user service corresponding the bearer service according to a user service deregistration request, upon completion of the deregistration of the bearer service.

In another exemplary embodiment, said creating a multicast channel according to the user service registration and the bearer service registration includes: collecting location information of UEs; and registering the bearer service on the basis of the location information of the UEs.

In another exemplary embodiment, said receiving a micro blog message from the service providing server and transmitting the micro blog message over the multicast channel includes transmitting the micro blog message to UEs simultaneously over the multicast channel.

### Advantageous Effects

As described above, the present invention transmits a micro blog message to a plurality of UEs over a multicast channel for providing a micro blog service, thereby making it possible to improve resource use efficiency. In particular, the micro blog service providing method of the present invention can improve resource use efficiency in a wireless Internet environment with limited resources.

### DESCRIPTION OF DRAWINGS

FIG. 1 is a diagram illustrating a structure of a communication system for providing a micro blog service in accordance with an exemplary embodiment of the present invention.

FIG. 2 is a schematic diagram illustrating a multicast channel managing operation between a UE, an eMB-SC and a service providing server in accordance with an exemplary embodiment of the present invention.

FIG. 3 is a block diagram illustrating a structure of the UE of FIG. 2 in accordance with an exemplary embodiment of the present invention.

FIG. 4 is a block diagram illustrating a structure of the eMB-SC of FIG. 2 in accordance with an exemplary embodiment of the present invention.

FIG. 5 is a block diagram illustrating a structure of the service providing server of FIG. 2 in accordance with an exemplary embodiment of the present invention.

FIG. 6 is a flow diagram illustrating a method for providing a micro blog service in a communication system in accordance with an exemplary embodiment of the present invention.

### BEST MODE

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention provides a service providing server, a broadcast/multicast service node, and a method for providing a micro blog service thereof, which can improve resource use efficiency.

The following description is made in the context of a micro blog service that is an example of a social network service (SNS), to which the present invention is not limited. Examples of the micro blog service include Twitter, MeToday, Daum Yozm, and KakaoSuda.

Also, the following description is made in the context of a 3GPP (3rd Generation Partnership Project) communication system, to which the present invention is not limited. Thus, it should be clearly understood that the present invention is also applicable to any other communication systems that provide a micro blog service.

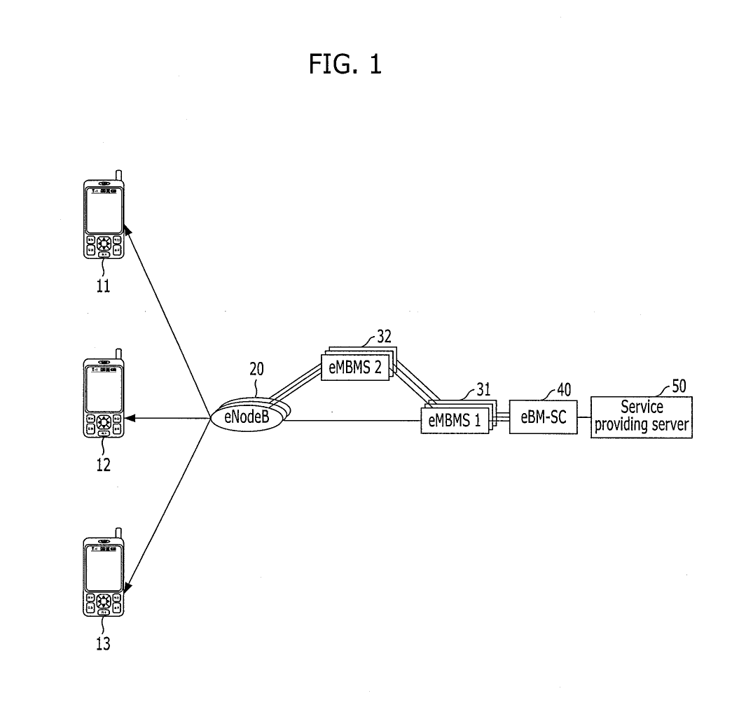

FIG. 1 is a diagram illustrating a structure of a communication system for providing a micro blog service in accordance with an exemplary embodiment of the present invention.

Referring to FIG. 1, a communication system includes terminals, e.g. user equipments (UEs) 11, 12 and 13, an eNodeB (base station) 20, a service node, e.g. a first evolved Multimedia Broadcast/Multicast Service (eMBMS) node 31, a second eMBMS node 32, a service providing node as a service center, e.g. an evolved Broadcast/Multicast Service Center (eBM-SC) 40, and a service providing server 50 as a contents providing server. Herein, the eNodeB 20, the first eMBMS node 31, and the second eMBMS node 32 may be provided in plurality.

The UEs 11, 12 and 13 are user devices that are connected to the eNodeB 20 to provide communication services to users. Also, the UEs 11, 12 and 13 may be connected to different eNodeBs.

The eNodeB 20 manages wireless resources of each cell. The eNodeB 20 communicates signals with UEs (e.g., the UE 11) in the corresponding cell through a wireless channel. The eNodeB 20 performs wireless resource management and wireless channel establishment according to signal communication with the UE 11.

The first eMBMS node 31 establishes an EMBMS traffic transmission path and transmits data through the transmission path. The first eMBMS node 31 has a gateway function.

The second eMBMS node 32 performs a session control function for supporting an EMBMS.

The eMB-SC 40 is a node that manages or controls an EMBMS. The eMB-SC 40 performs a Multimedia Broadcast/Multicast Service (MBMS) session initiation process and an MBMS session termination process with respect to all broadcast or multicast type EMBMSs.

The service providing server 50 sets and manages a bearer and a session for transmitting multimedia contents received from a contents provider (CP) or a service provider (SP). Accordingly, the service providing server can transmit multimedia contents simultaneously to a plurality of UEs. The service providing server 50 may provide only multimedia contents or may provide multimedia contents together with separate service logic.

Meanwhile, an Evolved Universal Terrestrial Radio Access Network (EUTRAN) includes UEs 11, 12 and 13, and an eNodeB (base station) 20.

An Evolved Packet Core (EPC) includes a first eMBMS node 31 and a second eMBMS node 32. The EPC sets an EMBMS multicast bearer in cooperation with the eNodeB 20. The EPC may transmit contents through the EMBMS multicast bearer.

In accordance with the present invention, the communication system providing a micro blog service transmits a micro blog message to the UEs 11, 12 and 13 in a push service mode. Thus, it does not construct a multicast tree with the UEs 11, 12 and 13 by receiving a join message.

The eMB-SC 40 obtains location information of terminals or user terminals, e.g. UEs and creates a multicast tree for the respective location regions of the UEs 11, 12 and 13 to receive a micro blog message. Herein, the eMB-SC 40 may generate a UE context for an EMBMS. The UE context may mean network path information for data transmission. For example, the UE context may include IP bearer service information or network internal routing information.

Therefore, in the communication system of the present invention, the UEs 11, 12 and 13, the eNodeB 20, the first MBMS node 31, the second MBMS node 32, and the eMB-SC 40 need not generate a UE context for an EMBMS. That is, the present invention generates a terminal context, e.g. UE context only in the eMB-SC 40.

In particular, the service providing server 50 provides the eMB-SC 40 with information of a UE to receive a micro blog message, and constructs a multicast path by the eMB-SC 40. Thus, it is possible to improve the wireless resource use efficiency for providing a micro blog service in the system providing a micro blog service of the present invention.

Also, the present invention can provide multimedia data (e.g., a micro blog message) to a plurality of UEs through one multicast channel according to location information of UEs. The present invention improves the wireless resource use efficiency, thus improving the total traffic transmission performance in the system.

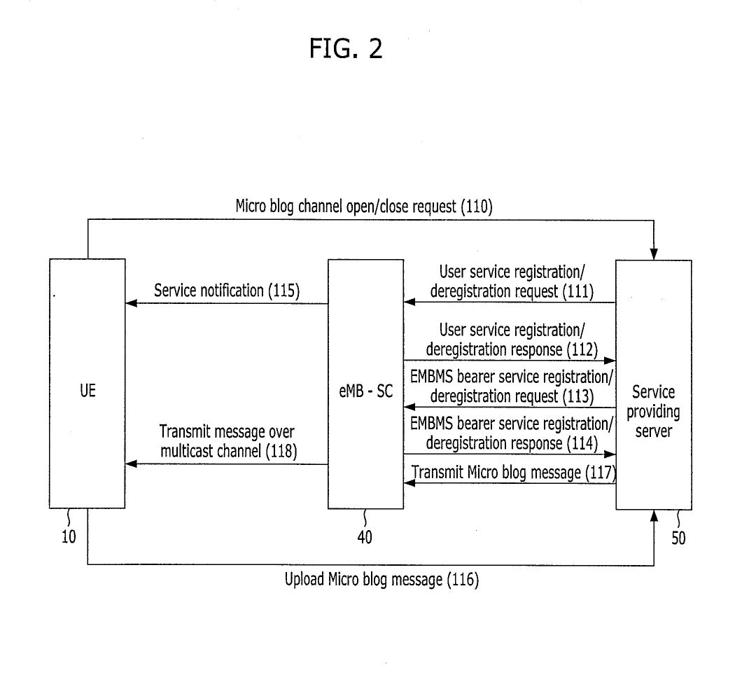

FIG. 2 is a schematic diagram illustrating a multicast channel managing operation between a UE, an eMB-SC and a service providing server in accordance with an exemplary embodiment of the present invention.

Referring to FIG. 2, a communication system includes a terminal, e.g. UE 10, an eMB-SC 40, and a service providing server 50.

The UE 10 interfaces with a user. For example, it is assumed that the UE 10 uses a micro blog service. The UE 10 may provide the user with a micro blog service such as Twitter. The UE 10 has an EMBMS function. Herein, although only one UE is illustrated for convenience in description, it may be one of UEs that receive a multimedia message according to the providing of a micro blog service.

The eMB-SC 40 is a node that controls an EMBMS. The eMB-SC 40 may transmit a micro blog message, generated according to the use of a micro blog service, to the UE 10 through one multicast channel.

The service providing server 50 provides contents and services. The service providing server 50 may be managed by a contents provider or a service provider. Also, the service providing server 50 may drive a specific micro blog service.

Hereinafter, a description will be given of an operation of providing a micro blog service in a communication system in accordance with an exemplary embodiment of the present invention.

The UE 10 may be connected to the service providing server 50. The UE 10 may be registered in the service providing server 50 (e.g., micro blog service subscription) to receive a micro blog service (e.g., micro blog service use authentication).

The UE 10 may transmit a micro blog channel open/close request to the service providing server 50 (step 110). The UE 10 transmits a micro blog channel open/close request message to the service providing server 50 through a default bearer on a communication network.

When receiving the micro blog channel open/close request from the UE 10, the service providing server 50 transmits a user service registration/deregistration request to the eMB-SC 40 (step 111).

In order to provide a user service (a micro blog service), the service providing server 50 may transmit a user service registration request message to the eMB-SC 40. The user service registration request message includes information about an EMBMS bearer service registration/activation indicator, a micro blog service identifier, a micro blog service name, a micro blog service data type, and a micro blog service user list.

If a micro blog service is not used any more, the service providing server 50 may transmit a user service deregistration request message to the eMB-SC 40.

Herein, the transmitting of the user service registration/deregistration request in step 111 corresponds to EMBMS service based service subscription. In the transmitting of the user service registration request in step 111, the service providing server 50 registers information, which is necessary to transmit multimedia messages provided by a micro blog service, to the eMB-SC 40. Also, the transmitting of the user service registration request in step 111 is to allocate resource information for setting a corresponding bearer service.

The eMB-SC 40 transmits auser service registration/deregistration response to the service providing server 50 in response to the user service registration/deregistration request (step 112).

When receiving the service registration request message, the eMB-SC 40 stores information, included in the service registration request message, in an internal database (not illustrated) for a corresponding EMBMS user service control.

The eMB-SC 40 transmits a user service registration response message to the service providing server 50 in response to the user service registration request message. The eMB-SC 40 generates a unique identifier corresponding to the user service registration request, and transmits a user service registration response message including the generated unique identifier to the service providing server 50. The user service registration response message includes user service registration result information (success or failure).

When receiving the user service deregistration request message, the eMB-SC 40 recovers a resource allocated at the service registration. For example, the user service deregistration request message may include a unique identifier that is allocated at the user service allocation to request user service deregistration. The eMB-SC 40 transmits a user service deregistration response message including the user service deregistration result according to the resource recovery to the service providing server 50. Herein, the transmitting of the user service deregistration response message may be omitted.

The service providing server 50 transmits an EMBMS bearer service registration/deregistration request to the eMB-SC 40 (step 113).

In order to set a bearer service, the service providing server 50 transmits an EMBMS bearer registration request message to the eMB-SC 40. The EMBMS bearer registration request message includes bearer service registration information such as a bearer service identifier, a bearer service name, a data type, location region information, and an EMBMS bearer activation initiation/termination time point.

In order to deregister a bearer service, the service providing server 50 transmits an EMBMS bearer deregistration request message to the eMB-SC 40. When there is a bearer service deregistration request from the UE 10, the service providing server 50 may request EMBMS bearer service deregistration through an EMBMS bearer deregistration request message including a bearer service identifier and a user service identifier.

The eMB-SC 40 transmits an EMBMS bearer service registration/deregistration response to the service providing server 50 in response to the EMBMS bearer service registration/deregistration request (step 114).

When receiving the EMBMS bearer service registration request message, the eMB-SC 40 allocates port information, an IP multicast address, and an identifier for an EMBMS bearer service to be used for multimedia message transmission to UEs of the corresponding service channel for bearer service registration, and stores the same in a database (not illustrated) together with information included in the bearer service registration request message.

By using the stored information, the eMB-SC 40 activates an EMBMS bearer service and generates an EMBMS bearer service registration response message including EMBMS bearer service activation result information, an EMBMS bearer service identifier, an IP multicast address, and port information. The eMB-SC 40 transmits the EMBMS bearer service registration response message to the service providing server 50.

The eMB-SC 40 activates an EMBMS bearer service according to the EMBMS bearer service activation initiation/termination time point in the EMBMS bearer service registration. However, the eMB-SC 40 activates an EMBMS bearer service for a micro blog service at the EMBMS bearer service registration request time point. Thus, the EMBMS bearer service registration request message includes an indicator for activating an EMBMS bearer at the EMBMS bearer service registration request time point and deactivating the EMBMS bearer at the EMBMS bearer channel termination time point.

When receiving the EMBMS bearer deregistration request message, the eBM-SC 40 deregisters an EMBMS bearer service through the user service identifier information included in the user service deregistration response message and the bearer service identifier information included in the bearer service deregistration request message. The eBM-SC 40 deletes EMBMS bearer service-related data stored in a database. The eBM-SC 40 transmits an EMBMS bearer service deregistration response message to the service providing server 50 in response to the EMBMS bearer service deregistration request message.

The eBM-SC 40 notifies an EMBMS service to the UE 10 (step 115).

Herein, the UE 10 may be a joining UE for a multicast tree configuration process, and may be a UE receiving a micro blog message. The eBM-SC 40 transmits an EMBMS service notification message to the UE 10. The EMBMS service notification message includes new service channel information. When the eMB-SC receives a multicast join message for service channel selection from the UE, the first MBMS node 31 with a gateway function in the EPC creates an EMBMS multicast tree for data transmission in cooperation with the eBM-SC 40 and the eNodeB 20.

The present invention transmits a micro blog message in a push mode according to the providing of a micro blog service. Thus, the eBM-SC 40 may omit the step 115 of transmitting the EMBMS service notification message.

However, the eBM-SC 40 searches the locations of the corresponding mobile terminals on the basis of the information received from the service providing server 50. Herein, the eBM-SC 40 constructs a multicast path in cooperation with the first MBMS node 31 and the eNodeB 20. The eBM-SC 40 may search location information of an UE in cooperation with a location detection server (or a location detection register). Thus, the eBM-SC 40 may construct a multicast path by using the location information of the UE, without constructing a multicast through a join processes from UEs.

The UE 10 may upload a micro blog message for a micro blog service to the service providing server 50 (step 116).

The UE 10 transmits the micro blog message to the service providing server 50 through a default bearer on the network. When receiving the micro blog message through a micro blog application implemented in the UE 10, the service providing server 50 receives location information of UEs, which is to receive the micro blog message, through the network.

If the service providing server 50 is to transmit the micro blog message of the UE 10 (e.g., generation of a follow message or generation of a reply), it requests micro blog message transmission from the eBM-SC 40 (step 117).

When requesting the micro blog message transmission, the service providing server 50 transmits it to the eBM-SC 40 together with a list of UEs that have received the micro blog message. Herein, the list information of a UE may be used to generate a multicast bearer by acquisition of the location information of a UE. The eBM-SC 40 may receive the location information of UEs, which are to receive the micro blog message of the UE 10, through the network (e.g., a location-based service (LBS) server, a location register, and an eNodeB).

The eMB-SC 40 transmits the multicast channel generated through the steps 111 to 114 (the channel created through the EMBMS bearer service setup) to the corresponding UE 10 (which is different from the UE that has uploads the micro blog message) (step 118).

When there is a change in the micro blog service (e.g., generation of a follow message or generation of a reply message), the service providing server 50 receives the generated messages. The service providing server 50 may transmit the generated messages to the eMB-SC 40 in an Internet Protocol (IP) packet format. Herein, the service providing server 50 may transmit the IP packet through the port number and the IP multicast address obtained in the step 114. Also, the service providing server 50 may transmit the IP packet as a unicast packet destined for the eMB-SC.

The IP packet received by the eMB-SC 40 may be transmitted through the EMBMS multicast bearer (multicast channel) activated through the EMBMS bearer service registration process. Also, a plurality of UEs receive the same message through one wireless channel. However, the message inputted from the UE is transmitted to the service providing server through a default bearer.

Accordingly, the present invention can transmit the micro blog message, generated by the micro blog service, to a plurality of UEs simultaneously through one multicast channel generated through the eMB-SC 40.

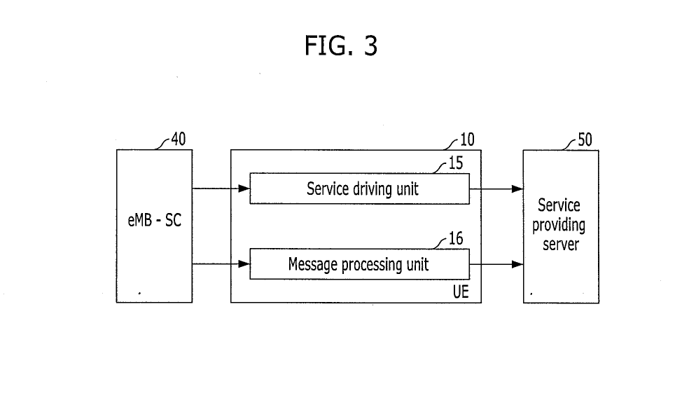

FIG. 3 is a block diagram illustrating a structure of the UE of FIG. 2 in accordance with an exemplary embodiment of the present invention.

Referring to FIG. 3, the UE 10 includes a service driving unit 15 and a message processing unit 16.

The service driving unit 15 drives a micro blog application for providing a micro blog service. The service driving unit 15 may receive an EMBMS service notification message through the eMB-SC 40. The service driving unit 15 may detect information about a new service channel through the service notification message.

However, when driving a micro blog service, the service driving unit 15 does not receive a service notification message because it receives a micro blog message in a push mode.

The message processing unit 16 may generate a micro blog message through an interface with the user or may output a received micro blog message to the user. The message processing unit 16 transmits the generated micro blog message to the service providing server 50. Also, the message processing unit 16 may receive the micro blog message through the multicast channel of the eMB-SC 40.

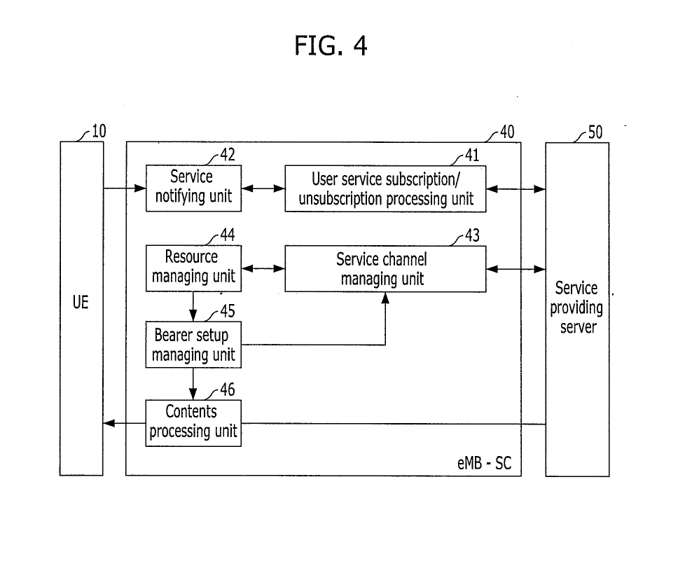

FIG. 4 is a block diagram illustrating a structure of the eMB-SC of FIG. 2 in accordance with an exemplary embodiment of the present invention.

Referring to FIG. 4, the eMB-SC 40 includes a user service subscription/unsubscription processing unit 41, a service notifying unit 42, a service channel managing unit 42, a resource managing unit 44, a bearer setup managing unit 45, and a contents processing unit 46.

The user service subscription/unsubscription processing unit 41 registers/deregisters service information for an EMBMS multicast bearer. The user service subscription/unsubscription processing unit 41 receives an information registration/deregistration request for an EMBMS bearer service or an EMBMS user service. According to the received information registration/deregistration request, the user service subscription/unsubscription processing unit 41 allocates/recovers an identifier and IP multicast address resource, and stores/deletes service information in a database (not illustrated). The user service subscription/unsubscription processing unit 41 transmits the allocated resource information to the service providing server 50.

Herein, the information stored in the database may be used for service notification, authorization, multicast tree configuration, EMBMS bearer service activation/deactivation, traffic transmission and signal communication such as traffic session control.

The user service subscription/unsubscription processing unit 41 registers a user service at a certain time point before the start of the corresponding service. In order to register a user service, the user service subscription/unsubscription processing unit 41 receives information about an indicator for requesting an EMBMS bearer service registration/activation function, a micro blog channel identifier, a micro blog service name, a data type for a micro blog service (e.g., a data type and data characteristics), and a user list for a micro blog service, from the service providing server 50.

In order to stop the providing of a user service, the user service subscription/unsubscription processing unit 41 receives a user service unsubscription request including a user service identifier from the service providing server 50. The user service subscription/unsubscription processing unit 41 recovers all resources allocated for a user service, and deletes all information stored in a database for resource allocation.

When completing the user service and the EMBMS bearer service registration, the service notifying unit 42 may transmit a service notification to the UE 10 for selection of a service desired by the user. If the eMB-SC 40 does not use a service notification function, the service notifying unit 42 may be omitted.

The service channel managing unit 43 generates a multicast channel by using location information of the UE from the service providing server 50. When a micro blog service channel open is requested by the UE 10, it receives an EMBMS bearer service registration request message through the service providing server 50. The EMBMS bearer service registration request message includes a user service identifier. Also, the EMBMS bearer service registration request message includes a bearer service name, a data type, location region information (for an EMBMS bearer service), and information about EMBMS bearer activation initiation/termination time points.

The service channel managing unit 43 may receive an EMBMS bearer service deregistration request message. According to the EMBMS bearer service registration/deregistration request message, the service channel managing unit 43 determines the registration/deregistration of an EMBMS bearer service. The service channel managing unit 43 may operate in cooperation with a user service channel managing unit in order to refer to the user information including the EMBMS bearer service.

The service channel managing unit 43 may request a resource allocation/recovery request for each user service channel from the resource managing unit 44 in order to generate/delete information necessary for bearer setup.

The service channel managing unit 43 may receive the result information according to the EMBMS bearer service allocation or the EMBMS bearer service release outputted through the bearer service managing unit 45. The service channel managing unit 43 may transmit an EMBMS bearer service setup/release response message to the service providing server 50.

The resource managing unit 44 may obtain location information of UEs through EPC and EUTRAN, and sets an EMBMS bearer by using the location information of the UEs. When resource allocation is requested, the resource managing unit 44 performs resource allocation for an EMBMS user service identifier, an EMBMS bearer service identifier, an IP multicast address for each EMBMS bearer service, port information, and Temporary Group Mobile Identity (TMGI) to be used in a control period of the communication network, in order to set the bearer. When resource recovery is requested, the resource managing unit 44 deletes resource allocation information stored in a database.

The resource managing unit 44 may request EMBMS bearer service setup and EMBMS bearer service release to the bearer setup managing unit 45 according to the resource allocation or the resource recovery.

When the resource allocation is completed by the resource managing unit 44, the bearer setup managing unit performs an operation for setting an EMBMS bearer service. The bearer setup managing unit 45 sets an EMBMS bearer by using the EMBMS bearer service setup information.

When the resource recovery is completed by the resource managing unit 44, the bearer setup managing unit performs an operation for releasing an EMBMS bearer service. The bearer setup managing unit 45 outputs the operation result of the EMBMS bearer service setup or the EMBMS bearer service release to the service channel managing unit 43.

When the EMBMS bearer service setup is completed, it is possible to transmit the micro blog message received from the service providing server 50. That is, the service channel managing unit 43 transmits the EMBMS bearer service setup completion to the service providing server 50.

The contents processing unit 46 receives micro blog messages uploaded by users, or micro blog messages transmitted from micro blog sites, from the service providing server 50. The contents processing unit 46 transmits a micro blog message corresponding to the micro blog according to the EMBMS bearer service setup to the UE 10.

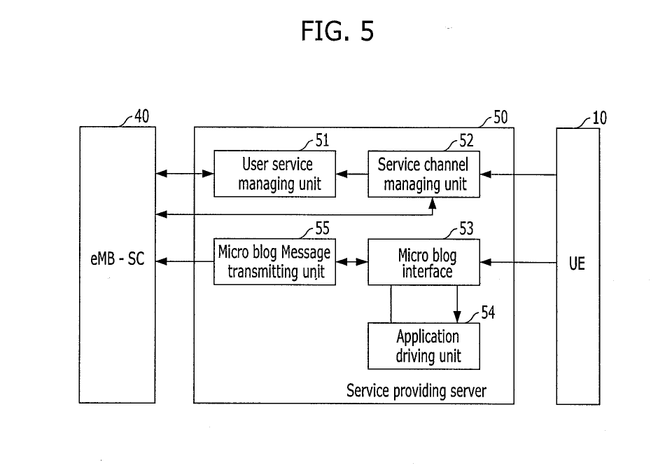

FIG. 5 is a block diagram illustrating a structure of the service providing server of FIG. 2 in accordance with an exemplary embodiment of the present invention.

Referring to FIG. 5, the service providing server 50 includes a user service managing unit 51, a service channel managing unit 52, a micro blog (MB) interface 53, and an application driving unit 54.

The user service managing unit 51 manages user service registration/deregistration. The user service managing unit 51 may register a user service through the eMB-SC 40 before the execution of a user service. Also, the user service managing unit 51 may deregister a user service through the eMB-SC 40 after completion of the use of a user service.

In order to register a user service, the user service managing unit 51 may transmit the user service subscription/unsubscription processing unit 41 receives information about an indicator for requesting an EMBMS bearer service registration/activation function, a micro blog channel identifier, a micro blog service name, a data type for a micro blog service, and a user list for a micro blog service, to the eMB-SC 40.

When transmitting a user service registration request message, the user service managing unit 51 may receive a user service registration response message. Herein, the user service registration response message includes a service registration result and a service identifier allocated at the service registration by the eMB-SC 40. The service identifier is a unique service identifier that is used by the eMB-SC to identify the corresponding service in the communication system.

The user service managing unit 51 transmits a user service deregistration request message to the eMB-SC by using the unique service identifier. The user service managing unit 51 may receive a user service deregistration response message from the eMB-SC 40.

The service channel managing unit 52 transmits an EMBMS bearer service request to the eMB-SC 40 after completion of the user service registration from the user service managing unit 51. The service channel managing unit 52 may receive an EMBMS bearer service identifier, an IP multicast address and port information from the eMB-SC 40 according to the user service registration.

The service channel managing unit 52 transmits an EMBMS bearer service deregistration request to the eMB-SC 40 after completion of the user service deregistration from the user service managing unit 51.

The service channel managing unit 52 may request EMBMS bearer service registration/deregistration through the user service managing unit 51. The service channel managing unit 52 may directly request EMBMS bearer service registration/deregistration through the eMB-SC 40. When a bearer for a bearer service is directly managed through the eMB-SC 40, the service channel managing unit 52 may register an EMBMS bearer service for UEs at every channel open request from the UE 10.

After completion of the EMB bearer service registration, the MB interface 53 may upload a micro blog message from the UE 10. The MB interface 52 provides the micro blog message to the application driving unit 52.

The MB interface 53 transmits the micro blog message to UEs (followers) through the control of the application driving unit 54. Herein, the MB interface 53 outputs the micro blog message of a wirelessly-connected UE to a micro blog message transmitting unit 55. Also, the MB interface transmits the micro blog message of a UE connected through a wired Internet to the wired Internet.

The application driving unit 54 drives a micro blog service application such as Twitter. The application driving unit 54 may provide an application program interface (API). The application driving unit 54 may use the API to manage cell-based information, GPS information provided by an UE, visit region history information, and multicast information. Also, the application driving unit 54 may provide the managed information to UEs if necessary.

The application driving unit 54 selects the UE to receive the micro blog message received through the micro blog interface 53. The application driving unit 54 controls the MB interface 53 to transmit the micro blog message to the target UE.

The micro blog message transmitting unit 55 uses the micro blog message outputted from the MB interface 53 to generate a micro blog packet required by the eMB-SC 40. Herein, the micro blog message may be generated into a multicast packet or a unicast packet destined for the eMB-SC 40.

When generating a multicast blog packet, the micro blog message transmitting unit 55 may use the information obtained from the service channel managing unit 52 through an EMBMS bearer service registration process, to obtain multicast address information and port information. When generating a unicast blog packet, the micro blog message transmitting unit 55 may receive an address of the eMB-SC 40 from the service channel managing unit 520.

The micro blog message transmitting unit 55 transmits the generated micro blog packet to the eMB-SC 40 so that it is transmitted through the corresponding bearer to the UE. The micro blog message transmitting unit 55 may directly transmit the multicast packet. Also, the micro blog message transmitting unit 55 may transmit the unicast packet to the eMB-SC 40 in an encapsulated manner.

The service providing server 50 performs a leading operation for providing a micro blog service to UEs in an EMBMS multicast mode.

In accordance with the present invention, the UE, the eMB-SC server and the service providing server includes functional modules for providing the micro blog service. However, they may further include other functional modules for providing other services.

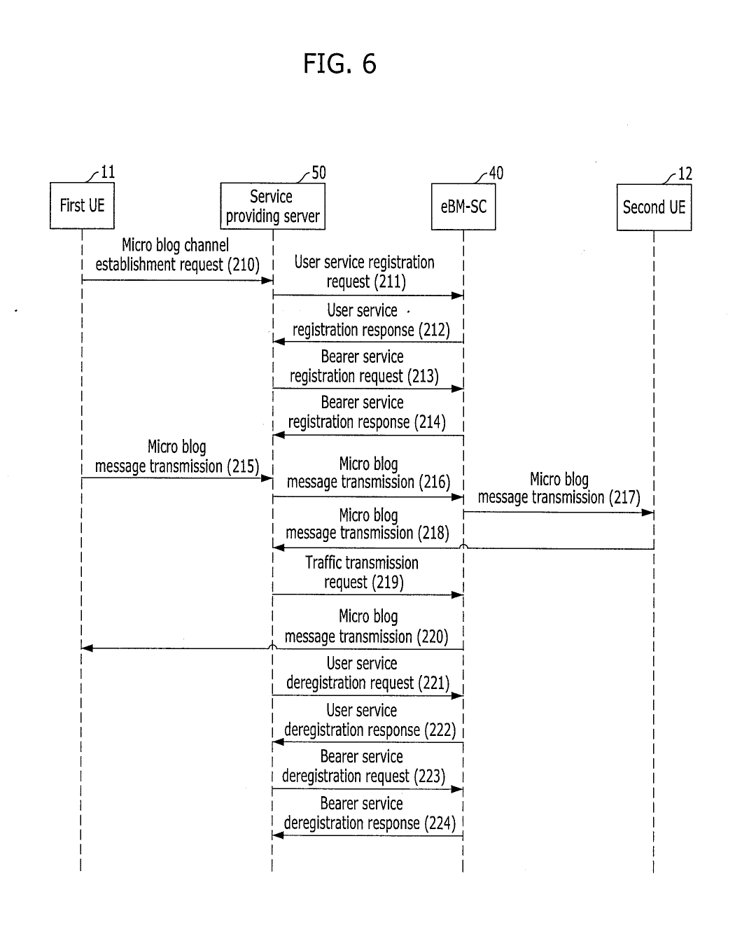

FIG. 6 is a flow diagram illustrating a method for providing a micro blog service in a communication system in accordance with an exemplary embodiment of the present invention.

Referring to FIG. 6, a first UE 11 transmits a micro blog channel open request to the service providing server 50 (step 210).

The service providing server 50 transmits a user service registration request to the eMB-SC 40 (step 211). Herein, the user service means a service desired by the user (e.g., Twitter). The service providing server 50 registers a user service for the first UE 11 in the eMB-SC 40.

Thereafter, the eMB-SC 40 transmits a user service registration response corresponding to the user service registration request to the service providing server 50 (step S212). The eMB-SC 40 registers the user service.

After completion of the user service registration, the service providing server 50 transmits an EMBMS bearer service registration request to the eMB-SC 40 (step S213). Herein, the EMBMS bearer service means a bearer service for creating a multicast channel. The eMB-SC 40 may transmit a micro blog message through a bearer registered by the bearer service registration,

The eMB-SC 40 registers an EMBMS bearer service and transmits an EMBMS bearer service registration response corresponding to the EMBMS bearer service registration request to the service providing server 50 (step S214).

The first UE 11 transmits a micro blog message to the service providing server 50 (step 215). That is, the first UE 11 transmits the micro blog message to the service providing server 50.

The service providing server 50 transmits the micro blog message to the eMB-SC 40 (step 216). Herein, the service providing server 50 may convert the micro blog message into a data packet used in the eMB-SC 40.

The eMB-SC 40 transmits the micro blog message to UEs (e.g., a second UE 12) through one multicast channel created through the EMBMS bearer service registration (step 217). Because the eMB-SC 40 transmits the micro blog message simultaneously through one multicast channel, each UE need not occupy a separate channel for transmission of the micro blog message.

The second UE 12 may also generate a micro blog message.

The second UE 12 transmits the micro blog message to the service providing server 50. Like the first UE 11, the second UE 12 may transmit the micro blog message through user service registration and EMBMS bearer service registration. Alternatively, without user service registration and bearer service registration, the UE 12 may transmit the micro blog message in response to the micro blog message of the first UE 11.

The service providing server 50 transmits a request for transmission of traffic such as the micro blog message received from the second UE 12 (step 219).

If the first UE 11 is to receive the micro blog message, the eMB-SC 40 transmits the micro blog message to the first UE 11 (step 220).

If there is no need to transmit the micro blog message to the first UE 11, the service providing server 50 transmits an EMBMS bearer service deregistration request to the eMB-SC 40 (step 221).

The eMB-SC 40 transmits an EMBMS bearer service deregistration response to the service providing server 50 in response to the EMBMS bearer service deregistration request (step 222).

After completion of the EMBMS bearer service deregistration corresponding to the bearer service deregistration response, the service providing server 50 transmits a user service deregistration request to the eMB-SC 40 (step 223).

The eMB-SC 40 deregisters a user service according to the user service deregistration request, and transmits a user service deregistration response to the service providing server 50 (step 224).

When receiving the user service deregistration response, the service providing server 50 may detect that a multicast channel for transmission of the micro blog message of the first UE 11 is removed from the eMB-SC 40.

Transmitting a micro blog message including small multimedia data (e.g., a message of 140 words or less) to UEs through wireless channels in a unicast mode in a wireless communication environment is inefficient in terms of the use of wireless resources. Thus, the present invention transmits a micro blog message to UEs (followers) simultaneously through one multicast channel. Therefore, the micro blog message transmission method of the present invention can reduce the waster of wireless resources, thus making it possible to improve the total network traffic performance. Also, the present invention can greatly improve the performance as the number of UEs receiving the micro blog message increases.

The present invention is applicable to a micro blog application such as Twitter, and is also applicable to a social network service (SNS) that transmits data between service users in a push mode.

While the present invention has been described with respect to the specific embodiments, it will be apparent to those skilled in the art that various changes and modifications may be made without departing from the spirit and scope of the invention as defined in the following claims.

1. A service providing server in a communication system, comprising:
a user service managing unit configured to register a user service in a service providing node according to a channel open request for a micro blog service of a user equipment (UE);
a service channel managing unit configured to establish a bearer service corresponding to the user service upon registration of the user service;
an application driving unit configured to drive a micro blog application to be used in the UE; and
a micro blog interface unit configured to output and transmit a micro blog message, received from the UE, to UEs to receive the micro blog message, by the driving of the micro blog application.

2. The service providing server of claim 1, wherein the service channel managing unit requests deregistration of the bearer service to the service providing node upon completion of the use of the user service by the UE.

3. The service providing server of claim 2, wherein the user service managing unit requests deletion of the user service upon completion of the bearer service deregistration request.

4. The service providing server of claim 1, further comprising a micro blog message transmitting unit configured to converts the micro blog message into a micro blog packet supported by the service providing node, and transmits the micro blog packet to the service providing node.

5. A service providing node in a communication system, comprising:
a user service subscription/unsubscription processing unit configured to register a user service upon receiving a user service registration request from a service providing server;
a service channel managing unit configured to receive a bearer service registration request according to the registration of the user service;
a resource managing unit configured to allocate a resource for registration of a bearer service according to the bearer service registration request;
a bearer setup managing unit configured to create a multicast channel through establishment of a bearer service according to the resource allocation; and
a contents processing unit configured to receive a multicast message of a user equipment (UE) corresponding to the user service from the service providing server, and transmit the same over the multicast channel.

6. The service providing node of claim 5, wherein upon receiving a bearer service deregistration request, the service channel managing unit recovers an allocated resource for the bearer service deregistration.

7. The service providing node of claim 6, wherein upon receiving a user service deregistration request from the service providing server, the user service subscription/unsubscription processing unit deregisters the registered user service.

8. The service providing node of claim 5, wherein for registration of a bearer service, the resource managing unit collects location information of UEs to receive a micro blog message.

9. The service providing node of claim 8, wherein the bearer setup managing unit registers the bearer service on the basis of the location information of the UEs.

10. The service providing node of claim 5, wherein the contents processing unit transmits the multicast message to UEs simultaneously over the multicast channel.

11. A service providing method at a service providing server in a communication system, comprising:
receiving a channel open request for a service from a user equipment (UE);
registering a user service and a bearer service corresponding to the user service in a service providing node, for establishment of a multicast channel according to the channel open request; and
transmitting a micro blog to the service providing node upon receiving the micro blog message from the UE.

12. The micro blog service providing method of claim 11, further comprising:
deregistering a bearer service from the service providing node upon detecting the need to disestablish the multicast channel; and
deregistering a user service corresponding the bearer service upon completion of the deregistration of the bearer service.

13. The micro blog service providing method of claim 11, wherein said transmitting a micro blog to the service providing node upon receiving the micro blog message from the UE comprises:
converting the micro blog message into a micro blog packet supported by the eMB-SS; and
transmitting the micro blog packet to the service providing node.

14. A service providing method at a service providing node in a communication system, comprising:
receiving a user service registration request and a bearer service registration request from a service providing server;
creating a multicast channel according to the user service registration and the bearer service registration; and
receiving a micro blog message from the service providing server and transmitting the micro blog message over the multicast channel.

15. The micro blog service providing method of claim 14, further comprising:
deregistering the bearer service according to the bearer service deregistration request; and
deregistering a user service corresponding the bearer service according to a user service deregistration request, upon completion of the deregistration of the bearer service.

16. The micro blog service providing method of claim 15, wherein said creating a multicast channel according to the user service registration and the bearer service registration comprises:
collecting location information of UEs; and
registering the bearer service on the basis of the location information of the UEs.

17. The micro blog service providing method of claim 14, wherein said receiving a micro blog message from the service providing server and transmitting the micro blog message over the multicast channel comprises transmitting the micro blog message to UEs simultaneously over the multicast channel.
